(19) United States
(12) Patent Application Publication
(10) Pub. No.: US 2018/0018179 A1
(43) Pub. Date: Jan. 18, 2018

(54) INTELLIGENT PRE-BOOT AND SETUP OF VEHICLE SYSTEMS

(71) Applicant: Ford Global Technologies, LLC, Dearborn, MI (US)

(72) Inventors: Nicholas Alexander Scheufler, Flat Rock, MI (US); David A. Herman, Southfield, MI (US); Nunzio DeCia, Northville, MI (US); Stephen Jay Orris, JR., New Boston, MI (US)

(21) Appl. No.: 15/207,829

(22) Filed: Jul. 12, 2016

(51) Int. Cl. G06F 9/44; H04W 4/00; H04L 29/08; H04W 12/06; B60R 16/037

(52) U.S. Cl. CPC G06F 9/441; H04W 12/06; B60R 16/037; H04L 67/306; H04W 4/008

(57) ABSTRACT

Systems and methods are disclosed for intelligent pre-boot and setup of vehicle systems. An example disclosed vehicle includes first sensors to detect a person within a user set in a first radius around the vehicle, second sensors to detect the person within a second radius around the vehicle; and a boot controller. The example boot controller activates vehicle subsystems in a first mode in response to detecting the person within the first radius. Additionally, the boot controller activates the vehicle subsystems in a second mode in response to detecting the person within the second radius.

### TECHNICAL FIELD

The present disclosure generally relates to customizing setting of a vehicle and, more specifically, intelligent pre-boot and setup of vehicle systems.

### BACKGROUND

Customers desire instantaneous personalization and readiness when they enter their vehicle. However, current vehicle electronic systems (e.g., infotainment systems, etc.) and electronic control units (ECUs) can take several minutes to boot-up, apply personal preferences, and download updated maps, itineraries, weather, traffic information, etc. As the amount of information and data the customer wants to access in the vehicle increases, so does this delay.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for intelligent pre-boot and setup of vehicle systems. An example disclosed vehicle includes first sensors to detect a person within a user set in a first radius around the vehicle, second sensors to detect the person within a second radius around the vehicle; and a boot controller. The example boot controller activates vehicle subsystems in a first mode in response to detecting the person within the first radius. Additionally, the boot controller activates the vehicle subsystems in a second mode in response to detecting the person within the second radius.

An example method to pre-boot subsystems of a vehicle includes detecting a person within a user set in a first radius around the vehicle with first sensors. The example method also includes detecting the person within a second radius around the vehicle with second sensors. Additionally, the example method includes activating vehicle subsystems in a first mode in response to detecting the person within the first radius. The example method includes activating the vehicle subsystems in a second mode in response to detecting the person within the second radius.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrated a vehicle operating in accordance with the teachings of this disclosure.

FIG. 2 is a block diagram of electronic components of the vehicle of FIG. 1.

FIG. 3 illustrates an example heat map used to predict occupants of the vehicle of FIG. 1.

FIG. 4 is a flowchart of an example method to pre-boot the systems of the vehicle of FIG. 1.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Vehicle occupants (e.g., drivers and passengers) often prefer having vehicle systems customized to fit their tastes. For example, a driver may prefer a particular seat position, steering column position, and mirror angles. As another example, a passenger may have preferred radio presets, seat warmer setting, and seat recline angle. Additionally, the occupants may want the infotainment system to download information on a cloud-based server, such as sports scores, email, weather, a preplanned itinerary, a contact list, a calendar, etc. As electronic control units (ECUs) and infotainment systems become more complicated and powerful, the time to boot up also increases. However, because of power consumption concerns, the infotainment system and the relevant ECUs cannot be continuously powered-on when the vehicle is shut off. As used herein, “vehicle subsystems” referred to the infotainment system and the ECUs of the vehicle.

As discussed below, a vehicle establishes two concentric detection zones around the vehicle. The zones are monitored by one or more sensors. For example, the first zone may be defined by a range of a key fob passive scanning system (e.g., 5-20 meters) and/or a Bluetooth® Low Energy module (e.g. 10 meters). In such an example, the second zone may be defined by range detection sensors (e.g., ultrasonic sensors, RADAR, LiDAR, etc.) at a smaller range (e.g., 1-3 meters, etc.) In some examples, the sensors that define the first zone analyze the trajectory of the detected object to distinguish between people passing through the first zone and people approaching the vehicle (e.g., a potential occupant). In such a manner, the vehicle pre-boots when a potential occupant is detected, but not when an object merely passes nearby the vehicle. Upon detection of an approaching potential occupant in the first zone, the vehicle begins to pre-boot the infotainment system and/or the ECUs. Additionally, in some examples, the vehicle downloads profiles of potential occupants from a cloud-based server. The ECUs and applications executing on by the infotainment system pre-boot based on prioritization factors, such as total time to boot, power consumption and quantity of data to be downloaded. The occupants are distinguished (e.g., between the driver and the passengers) and identified in response to entering the second zone. In some examples, when the potential occupant enters the second zone, sensors (e.g., cameras, biometric sensors, etc.) are activated to identify the occupant from a set of known potential occupants. When the driver and/or the occupants are identified, the vehicle continues to pre-boot by tailoring the infotainment system and the vehicle systems based on the downloaded profiles. In some examples, when the vehicle is autonomous, the vehicle identifies the occupants without distinguishing a driver.

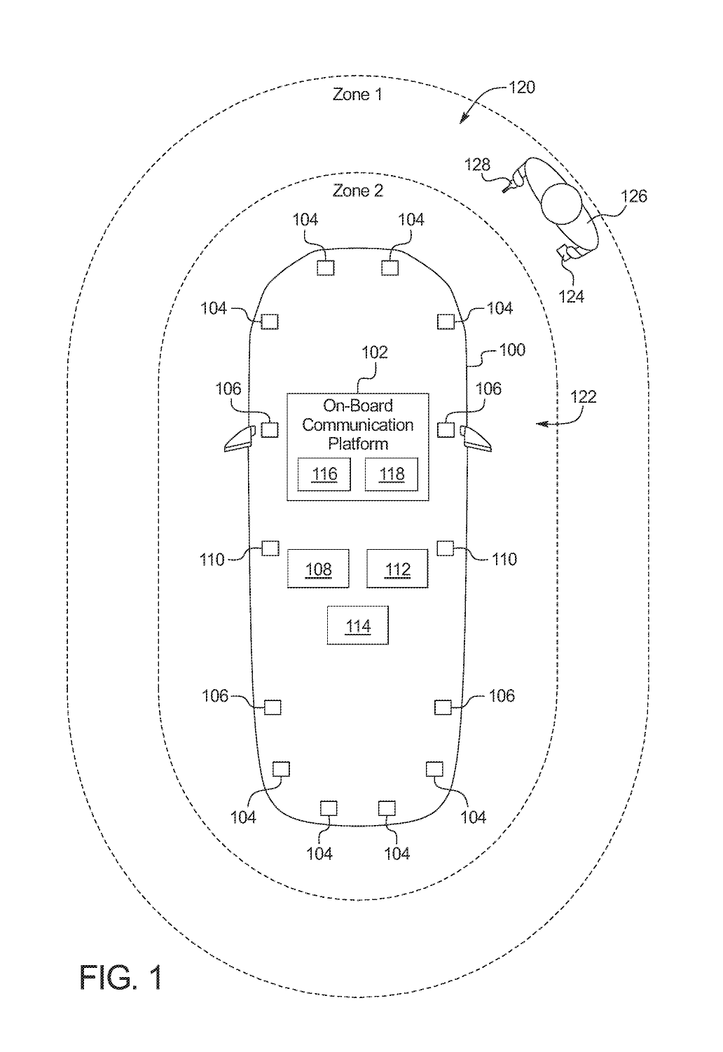

FIG. 1 illustrated a vehicle 100 operating in accordance with the teachings of this disclosure. The vehicle 100 may be standard gasoline powered vehicles, hybrid vehicles, electric vehicles, fuel cell vehicles, and/or any other mobility implement type of vehicle. The vehicle 100 included parts related to mobility, such as a powertrain with an engine, a transmission, a suspension, a driveshaft, and/or wheels, etc. The vehicle 100 may be non-autonomous, semi-autonomous, or autonomous. In the illustrated example, the vehicle 100 includes an on-board communications platform 102, range detection sensors 104, wireless nodes 106, a passive key fob scanner 108, cameras 110, a preboot control unit 112, and a preference distinguisher 114.

The on-board communications platform 102 includes wired or wireless network interfaces to enable communication with external networks. The on-board communications platform 102 also includes hardware (e.g., processors, memory, storage, antenna, etc.) and software to control the wired or wireless network interfaces. In the illustrated example, the on-board communications platform 102 includes a cellular modem 116 and a wireless local area network (WLAN) controller 118. The cellular modem 116 includes hardware and software to control wide area standards based networks (e.g., Global System for Mobile Communications (GSM), Universal Mobile Telecommunications System (UMTS), Long Term Evolution (LTE), Code Division Multiple Access (CDMA), etc.) operated by telecommunication companies. The WLAN controller 118 includes hardware and software to communication with wireless local area standards based networks (WiMAX (IEEE 802.16m) local area wireless network (including IEEE 802.11 a/b/g/n/ac/p or others), and Wireless Gigabit (IEEE 802.11ad), etc.). In some examples, the on-board communication platform includes controller(s) for personal area networks (e.g., Near Field Communication (NFC), Bluetooth®, etc.). The on-board communications platform 102 may also include a global positioning system (GPS) receiver. Further, the external network(s) may be a public network, such as the Internet; a private network, such as an intranet; or combinations thereof, and may utilize a variety of networking protocols now available or later developed including, but not limited to, TCP/IP-based networking protocols. The on-board communications platform 102 may also include a wired or wireless interface to enable direct communication with an electronic device (such as, a smart phone, a tablet computer, a laptop, etc.).

In the illustrated example, the range detection sensors 104 are mounted on the vehicle 100 to detect objects (e.g., people, vehicles, etc.) in the vicinity of the vehicle 100. The range detection sensors 104 may include ultrasonic sensors, RADAR, LiDAR, and/or infrared sensors, etc. The range detection sensors 104 detect the distance and/or relative size of the objects from the vehicle 100. The range detection sensors 104 may be used to establish a first zone 120 and/or a second zone 122 around the vehicle 100. For example, a first alert may be triggered when the range detection sensors 104 detect an object within 30 feet of the vehicle 100, and a second alert may be triggered when range detection sensors 104 detect an object within 5 feet of the vehicle 100. In such an example, the second alert may activate another sensor (e.g., the cameras 110) to identify the object approaching the vehicle 100. Additionally, in some examples, the range detection sensors 104 may track a trajectory of the detected object to distinguish between objects approaching the vehicle 100 and objects passing by the vehicle 100.

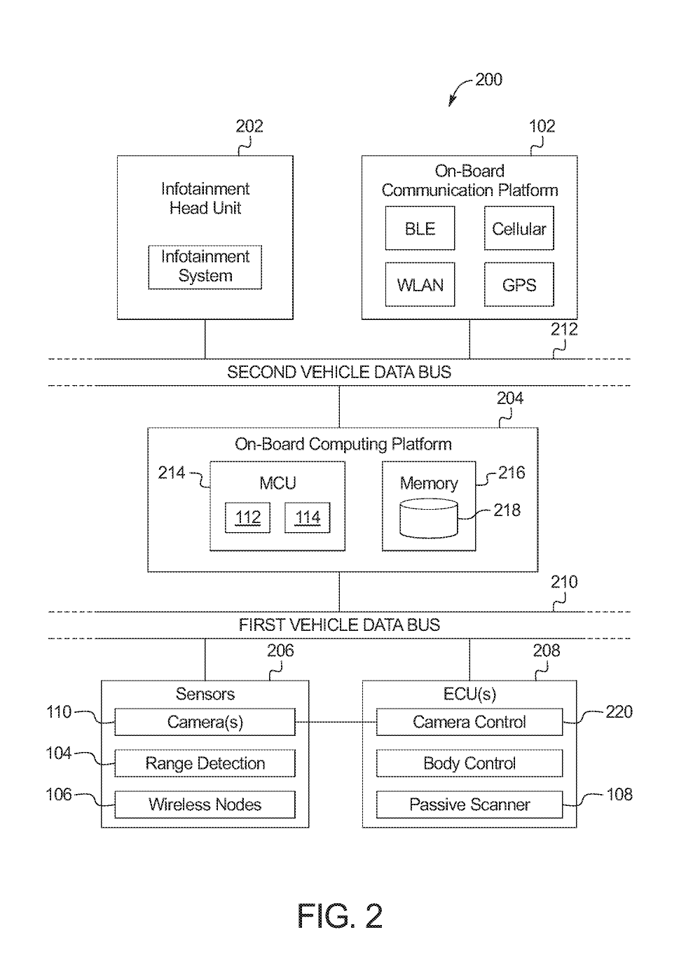

In the illustrated example, the wireless nodes 106 are positioned around the vehicle 100. For example, the wireless nodes 106 may be installed near a driver's side front door, a driver's side rear door, a passenger's side front door, and/or a passenger's side rear door. When activated, the wireless nodes 106 establish connections with mobile device(s) 118 that have been paired to the wireless nodes 106. The mobile device(s) 118 may be paired with the wireless nodes 106 during a setup process via an infotainment head unit (e.g., the infotainment head unit 202 of FIG. 2 below). The example wireless nodes 106 implement Bluetooth Low Energy (BLE). The BLE protocol is set forth in Volume 6 of the Bluetooth Specification 4.0 (and subsequent revisions) maintained by the Bluetooth Special Interest Group.

Messages exchanged between the mobile device(s) 118 and the wireless nodes 106 include the RSSI and/or the RX values between the mobile device(s) 118 and the wireless nodes 106. The RSSI and RX values measure the open-path signal strength of the radio frequency signal as received by the mobile device 124 from the corresponding wireless node 106. The RSSI is measured in signal strength percentage, the values (e.g., 0-100, 0-137, etc.) of which are defined by a manufacturer of hardware used to implement the wireless nodes 106. Generally, a higher RSSI means that the mobile device 124 is closer to the corresponding wireless nodes 106. The RX values are measured in Decibel-milliWatts (dBm). For example, when the mobile device 124 is one meter (3.28 feet) away, the RX value may be −60 dBm, and when the mobile device is two meters (6.56 feet) away, the RX value may be −66 dBm. The RSSI/RX values are used to determine the radial distance from the mobile device 124 to the particular wireless nodes 106. In some examples, using trilateration, the wireless nodes 106 are used to determine the location(s) of the mobile device(s) 118 relative to the vehicle 100.

In some examples, the wireless nodes 106 are used to establish the first zone 120 and/or the second zone 122 around the vehicle 100. Alternatively, in some examples, the wireless nodes 106 are used to establish the first zone at a first distances, and the range detection sensors 104 are used to establish the second zone at a second distance closer to the vehicle 100. Additionally, in some examples, the wireless nodes 106 may be used to identify a person 126 associated with the mobile device 124. For example, during the setup process, an identifier (e.g., a user name, a device identity number, etc.) associated with the mobile device 124 maybe associated with a profile of an occupant of the vehicle 100. In some examples, the wireless nodes 106 may be used to distinguish drivers and passengers. Examples of distinguishing drivers and passengers are described in U.S. patent application Ser. No. 15/080,132, entitled “Driver Identification Using Vehicle Approach Vectors,” which is herein incorporated by reference by its entirety.

The passive key fob scanner 108 detects when a key fob 128 associated with the vehicle 100 is within a radius (e.g., 9 feet, etc.) of the vehicle The passive key fob scanner 108 generates a low power, low frequency signal that is detected by the key fob 128. The key fob 128 responds to the signal to establish that it is the key fob 128 paired with (e.g., is authorized to access) the vehicle 100. In some examples, the passive key fob scanner 108 is used to establish the first zone 120. For example, when the passive key fob scanner 108 the key fob 128, the preboot control unit 112 may initiate a first level of booting the infotainment system and the ECUs of the vehicle 100. Additionally, in some examples, the passive key fob scanner 108 identifies the driver of the vehicle 100. In such examples, a key fob identifier is associated with the key fob 128 that uniquely identifies the key fob 128. In some such examples, the key fob identifier is associated with a profile of a possible driver of the vehicle 100.

In the illustrated example, the vehicle 100 includes cameras 110 monitoring an area around the vehicle 100. In some examples, the cameras 110 are used to establish the first zone 120 and/or the second zone 122. In some such examples, the cameras 110 perform distance estimation and object recognition to determine whether a person (e.g., the person 126) is approaching the vehicle 100 from within the first zone 120. In some examples, when the person 126 is in the second zone 122, the cameras 110 perform facial recognition or other biometric analysis (e.g., height analysis, body mass analysis, iris analysis, gait analysis, etc.) to determine the identity of the person 126.

To facilitate facial recognition or other biometric analysis, the mobile device 124 may include an application to enroll the person 126. Via the application, the person 126 enters identifying information to be associated with the profile of the person 126. For example, using a camera on the mobile device 124, the application may capture the facial features of the person 126. When the mobile device 124 is communicatively coupled to the vehicle 100 (e.g., via the wireless nodes 106, etc.), the application sends the identifying information to the vehicle 100.

The preboot control unit 112 of the illustrated example establishes the first zone 120 and the second zone 122. In some examples, the preboot control unit 112 defines the first zone 120 with sensors that determine whether the object in the first zone 120 is a user within a set of known users. Additionally, in some examples, the preboot control unit 112 defines the second zone 122 with sensors that identify the user from within the set of known users. The preboot control unit 112 defines the zones 120 and 122 with the range detection sensors 104, the wireless nodes 106, the passive key fob scanner 108 and/or the cameras 110, singly or in combination. For example, the preboot control unit 112 may define the first zone 120 using the passive key fob scanner 108 and the second zone using the cameras 110. In such an example, the key fob 128 detected by the passive key fob scanner 108 may be associated with a known of users. Upon detection of an approaching potential occupant (e.g., the person 126) in the first zone 120, the preboot control unit 112 begins to boot the infotainment system (e.g., the operating system, applications instantiated by the operating system, etc.) and/or the ECUs (e.g., the engine control unit, the brake control module, transmission control unit, etc.). The ECUs and applications instantiated by the infotainment system are booted based on prioritization factors, such as (i) total time to boot (e.g., the longer boot time, the higher the priority), (ii) power consumption (e.g., the higher the power consumption, the higher priority) and (iii) quantity of data to be downloaded (e.g., the larger the quantity, the higher the priority). Additionally, in some examples, the preboot control unit 112 downloads, via the on-board communications platform 102, the profiles of potential occupants from a cloud-based server. The profiles of potential occupants may include (a) people identified as being an occupant of the vehicle 100 before, (b) people that, during enrollment on the application on the mobile device, specify the vehicle 100, and/or (c) a list maintained by the owner of the vehicle 100.

In response to detection one or more people approach the vehicle 100 in the second zone 122, the preboot control unit 112 identifies the potential occupants. In some examples, when multiple people are approaching the vehicle 100 in the second zone 122, the preboot control unit 112 which one of the people is the driver and which one(s) of the people is/are the passenger(s). In some examples, the preboot control unit 112 uses the cameras 110 to identify the people as they approach the doors of the vehicle 100. Alternatively or additionally, in some examples, the preboot control unit 112 identifies the driver and the passenger(s) based on mobile devices (e.g., the mobile device 124). For example, if the person is carrying a mobile device that has been previously paired with the vehicle 100, the preboot control unit 112 may retrieve a profile associated with an identifier corresponding to the mobile device. When the driver and/or the occupants are identified, the preboot control unit 112 tailors the systems (e.g., seat position, steering column position, mirror position, temperature setting, radio presets, etc.) of the vehicle 100 based on the downloaded profiles of the identified occupants. Additionally, the preboot control unit 112 downloads, via the on-board communications platform 102, tailored information for applications executing on the infotainment system. The tailored information includes email, text messages, maps, traffic data, schedules, weather data, sport scores, news headlines, and/or entertainment (e.g., music, movies, television shows, podcasts, electronic books, etc.), etc. In some examples, the vehicle 100 includes multiple displays (e.g., a center console display, a passenger seat display, head rest displays, etc.). In such examples, based on identifying the location within the vehicle 100 of the identified occupants, the preboot control unit 112 displays tailored information on the display corresponding to the particular occupant.

In the illustrated example, the preference distinguisher 114 learns the preferences of the occupants using statistical algorithms and confidence thresholds. The preference distinguisher 114 tracks preferences for systems of the vehicle 100 and application information (e.g., frequently checks sports scores, but not news headlines) and links the preferences to the corresponding profile of the occupant. Additionally, the preference distinguisher 114 tracks the occupancy of the vehicle based on the day, the time of day, calendar and social networking application entries on the paired mobile devices 124, etc. to learn the different potential occupants for the vehicle 100. The preference distinguisher 114 collects information from the paired mobile devices 124 and/or the key fobs 128 to continuously assess and catalog this information to predict the driver and/or the occupant(s) of the vehicle 100. Additionally, in some examples, the preference distinguisher 114 analyzes type of information accessed by the occupant(s) of the vehicle 100 to determine which types of the tailored data the occupant(s) access. In such a manner, when the vehicle 100 preboots, the preboot control unit 112 downloads and presents the tailored data according to the preferences of the particular occupant. For example, if an occupant access email data and sports score data, but not news data, upon preboot, the preboot control unit 112 downloads and presents email data and sports score data.

In some examples, the preference distinguisher 114 is communicatively coupled (e.g., via one of the wireless nodes 106, via the WLAN controller 118, etc.) to an application executing on the mobile device 124. In such examples, the preference distinguisher 114 triggers an enrollment process in response to connecting to a paired mobile device 124 that is not associated with an occupant profile. The enrollment process collects data about the person 126 associated with the mobile device 124, such as schedules, geographic coordinates, travel history, etc. Additionally, in some examples, during the enrollment process, the mobile device 124 collects biometric data from the corresponding person 126 that may be used by the preboot control unit 112 to identify the occupants of the vehicle. For example, the application may provide guidance to the person 126 to record specific facial images with predetermined facial orientations and poses. As another example, the application may instruct the person 126 to stand in a particular area or walk in a certain way for the vehicle 100 to record biometric data. Additionally, in some examples, during the enrollment process, the application requests login credentials to social media sites (e.g., email, Facebook®, Twitter®, etc.) to facilitate messages from social media being downloaded to the vehicle 100. In some examples, during the enrollment process, the application queries the person 126 regarding vehicle setting preferences.

FIG. 2 is a block diagram of electronic components 200 of the vehicle 100 of FIG. 1. In the illustrated example, the electronic components 200 include the on-board communications platform 102, an infotainment head unit 202, an on-board computing platform 204, sensors 206, ECUs 208, a first vehicle data bus 210, and a second vehicle data bus 212.

The infotainment head unit 202 provides an interface between the vehicle 100 and a user (e.g., a driver, a passenger, etc.). The infotainment head unit 202 includes digital and/or analog interfaces (e.g., input devices and output devices) to receive input from the user(s) and display information. The input devices may include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a heads-up display, a center console display (e.g., a liquid crystal display (“LCD”), an organic light emitting diode (“OLED”) display, a flat panel display, a solid state display, etc.), and/or speakers. In the illustrated example, the infotainment head unit 202 includes hardware (e.g., a processor or controller, memory, storage, etc.) and software (e.g., an operating system, etc.) for the infotainment system. Additionally, the infotainment head unit 202 displays the infotainment system on, for example, the center console display. Applications instantiated by the infotainment system display information to the occupants, such as email, text messages, maps, traffic data, schedules, weather data, sport scores, news headlines, and/or entertainment. The preboot control unit 112 may download this information via the on-board communications platform 102 in response to identifying potential occupants of the vehicle 100 approaching in the second zone 122.

The on-board computing platform 204 includes a processor or controller 214 and memory 216. In some examples, the on-board computing platform 204 is structured to include the preboot control unit 112 and the preference distinguisher 114. Alternatively, in some examples, the preboot control unit 112 and/or the preference distinguisher 114 may be incorporated into an ECU 208 with their own processor and memory. The processor or controller 214 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 216 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 216 includes multiple kinds of memory, particularly volatile memory and non-volatile memory. In the illustrated example, the memory 216 includes a profile database 218 to store the profiles of potential occupants downloaded by the preboot control unit 112.

The memory 216 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 216, the computer readable medium, and/or within the processor 214 during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The sensors 206 may be arranged in and around the vehicle 100 in any suitable fashion. The sensors 206 may measure properties around the exterior of the vehicle 100. Additionally, some sensors 206 may be mounted inside the cabin of the vehicle 100 or in the body of the vehicle 100 (such as, the engine compartment, the wheel wells, etc.) to measure properties in the interior of the vehicle 100. For example, such sensors 206 may include accelerometers, odometers, tachometers, pitch and yaw sensors, wheel speed sensors, microphones, tire pressure sensors, and biometric sensors, etc. In the illustrated example, the sensors 206 include the range detection sensors 104 (e.g., LiDAR, RADAR, ultrasonic, etc.), the wireless nodes 106, and the cameras 110.

The ECUs 208 monitor and control the subsystems of the vehicle 100. The ECUs 208 communicate and exchange information via the first vehicle data bus 210. Additionally, the ECUs 208 may communicate properties (such as, status of the ECU 208, sensor readings, control state, error and diagnostic codes, etc.) to and/or receive requests from other ECUs 208. Some vehicles 100 may have seventy or more ECUs 208 located in various locations around the vehicle 100 communicatively coupled by the first vehicle data bus 210. The ECUs 208 are discrete sets of electronics that include their own circuit(s) (such as integrated circuits, microprocessors, memory, storage, etc.) and firmware, sensors, actuators, and/or mounting hardware. In the illustrated example, the ECUs 208 include the passive key fob scanner 108, a body control unit, and a camera control unit 220. The ECUs 208 may also include, for example, an autonomy unit, a engine control unit, a battery management unit, and a transmission control unit, etc. Additionally, ECUs 208 may receive personalized data from the preboot control unit 112 downloaded from an external server. For example, the engine control unit may receive optimization parameters that match the driver's preferences, or the autonomy unit may receive map data corresponding to planned routes. The camera control unit includes hardware and software to perform object recognition, facial recognition, and/or other recognition based on other biometric features (e.g., iris, retina, gait, height, body mass, etc.).

The first vehicle data bus 210 communicatively couples the sensors 206, the ECUs 208, the on-board computing platform 204, and other devices connected to the first vehicle data bus 210. In some examples, the first vehicle data bus 210 is implemented in accordance with the controller area network (CAN) bus protocol as defined by International Standards Organization (ISO) 11898-1. Alternatively, in some examples, the first vehicle data bus 210 may be a Media Oriented Systems Transport (MOST) bus, or a CAN flexible data (CAN-FD) bus (ISO 11898-7). The second vehicle data bus 212 communicatively couples the on-board communications platform 102, the infotainment head unit 202, and the on-board computing platform 204. The second vehicle data bus 212 may be a MOST bus, a CAN-FD bus, or an Ethernet bus. In some examples, the on-board computing platform 204 communicatively isolates the first vehicle data bus 210 and the second vehicle data bus 212 (e.g., via firewalls, message brokers, etc.). Alternatively, in some examples, the first vehicle data bus 210 and the second vehicle data bus 212 are the same data bus.

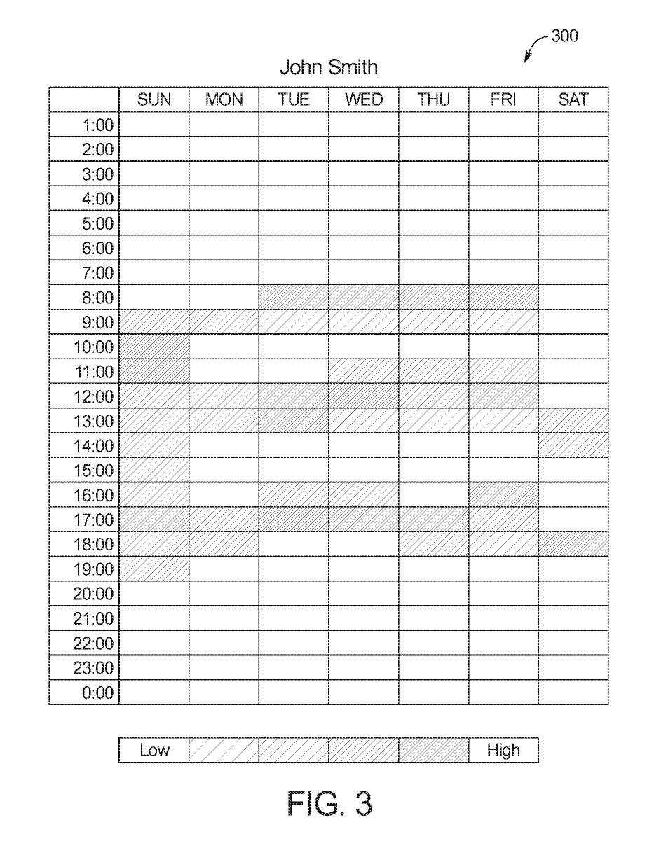

FIG. 3 illustrates an example heat map 300 used by the preference distinguisher 114 to predict occupants of the vehicle 100 of FIG. 1. The heat map 300 of the illustrated example uses time of day and day of the week to measure the occurrence rate that a particular person is the driver. Additionally, in some examples, the heat map 300 records instances of particular function/feature usage to learn habits and what a particular occupants does most frequently and when. The preference distinguisher 114 determines which one of the people approaching the vehicle 100 is the driver. For example, the application executing on the mobile device 124 may, from time-to-time, ask the person 126 if they are the driver in response to detecting the person 126 in the second zone 122. Over time, the preference distinguisher 114 generates the heat map 300. The preference distinguisher 114 to predict which person approaching the vehicle 100 is the driver. For example, when two people are approaching the vehicle 100, the preference distinguisher 114 may bias the selection of which person will likely be the driver based on the heat map 300.

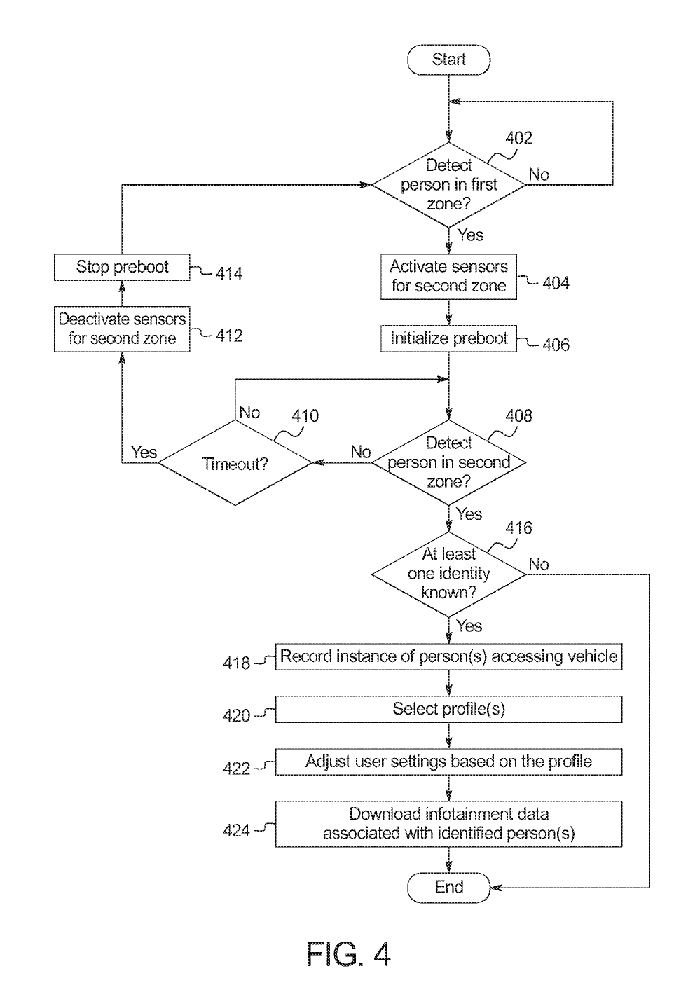

FIG. 4 is a flowchart of an example method to boot the systems of the vehicle 100 of FIG. 1. At block 402, the preboot control unit 112 waits to detect one or more people 126 in the first zone 120. The preboot control unit 112 detects the one or more people 126 via one or more sensors 206 configured to detect objects in the first zone 120. When one or more people 126 are detected in the first zone 120, at block 404, the preboot control unit 112 activates sensors 206 configured to detection the one or more people 126 in the second zone 122. For example, the passive key fob scanner 108 may be configured to detect the one or more people 126 in the first zone 120, and the wireless nodes 106 and the cameras 110 may be configured to detect the one or more people 126 in the second zone 122. Additionally, at block 406, the preboot control unit 112 initializes a preboot of the infotainment system and/or ECUs 208. For example, the preboot control unit 112 may boot the infotainment system. In some examples, the preboot control unit 112 downloads, via the on-board communications platform 102, profiles stored on an external network corresponding to possible identities of the one or more people 126 detected at block 402. Additionally, as part of the preboot, the preboot control unit 112 initializes a timer.

At block 408, the preboot control unit 112 determines whether the one or more people 126 are in the second zone 122. If the preboot control unit 112 detects the one or more people 126 are in the second zone 122, the method continues at block 416. Otherwise, if the preboot control unit 112 does not detect the one or more people 126 are in the second zone 122, the method continues at block 410. At block 410, the preboot control unit 112 determines whether the timer set at block 406 has satisfies (e.g., is greater than) a timeout threshold. The timeout threshold is set to determine when the one or more people 126 detected in the first zone 120 at block 402 are not actually going enter the vehicle 100. In some examples, the timeout threshold may be 30 seconds. If the timer satisfies the timeout threshold, the method continues at block 412. Otherwise, if the timer does not satisfy the timeout threshold, the method returns to block 408. At block 412, the preboot control unit 112 deactivates the sensors 206 activated at block 404. At block 414, the preboot control unit 112 ends prebooting the infotainment system and the ECUs 208.

At block 416, the preboot control unit 112 determines whether the identity of at least one of the people 126 detected at block 408 is known. To determines whether the identity of at least one of the people 126 is known, the preboot control unit 112 uses the sensors 206 activated at block 404 to identify the people 126 detected at block 408. For example, the camera control unit 220 may, using the cameras 110, perform facial or other biometric recognition based on biometric data associated with the profiles downloaded at block 406. Additionally, in some examples, the preboot control unit 112 determines which one of the people 126 detected at block 408 is the driver. As another example, an identifier corresponding to the mobile device 124 detected by the wireless nodes 106 may be associated with the profiles downloaded at block 406. If at least one of the people 126 detected is known, the method continues to block 418. Otherwise, if none of the people 126 are known, the method ends.

At block 418, the preference distinguisher 114 records an instance of the person(s) 126 identified at block 416 accessing the vehicle 100. The preference distinguisher 114 may use the recorded instance to create or modify a heat map (e.g., the heat map 300 of FIG. 3) associated with the profile of the person identified at block 416. At block 420, the preboot control unit 112 selects the profile(s) downloaded at block 406 corresponding to the person(s) 126 identifies at block 416. At block 422, the preboot control unit 112 adjusts the setting of the systems of the vehicle 100 (e.g., climate control, seat position, steering wheel position, mirror positions, radio presets, seat warmers, etc.). At block 424, the preboot control unit 112 downloads, via the on-board communications platform 102, infotainment data (e.g., email, text messages, maps, traffic data, schedules, weather data, sport scores, news headlines, itineraries, music, movies, television shows, podcasts, electronic books, social media data, etc.) and other ECU data (e.g., autonomous map data for an autonomy unit that includes planned routes and/or commonly traveled routes, etc.) associated with the person(s) 126 identified at block 416.

The flowchart of FIG. 4 is a method that may be implemented by machine readable instructions that comprise one or more programs that, when executed by a processor (such as the processor 214 of FIG. 2), cause the vehicle 100 to implement the preboot control unit 112 and/or the preference distinguisher 114 of FIG. 1. Further, although the example program(s) is/are described with reference to the flowchart illustrated in FIG. 4, many other methods of implementing the example preboot control unit 112 and/or the example preference distinguisher 114 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
first sensors to detect a person within a user set in a first radius around the vehicle;
second sensors to detect the person within a second radius around the vehicle; and
a boot controller to:
activate vehicle subsystems in a first mode in response to detecting the person within the first radius; and
activate the vehicle subsystems in a second mode in response to detecting the person within the second radius.

2. The vehicle of claim 1, wherein the second radius is smaller than the first radius.

3. The vehicle of claim 1, including third sensors to identify the person in response to the detecting the person within the second radius.

4. The vehicle of claim 3, wherein the second sensors and the third sensors are the same sensors.

5. The vehicle of claim 1, wherein the first mode includes downloading profiles of persons associated with the vehicle from an external server.

6. The vehicle of claim 1, wherein the boot controller is to activate electronic control units of the vehicle in a prioritized order.

7. The vehicle of claim 6, wherein the prioritized order is based on at least one of a function of the vehicle subsystems, a total time to boot, power consumption of the vehicle subsystems.

8. The vehicle of claim 1, wherein the boot controller is to identify the person with the second sensors in response to detecting the person within the second radius, wherein the second mode includes downloading, from an external server, tailored data associated with a profile corresponding to the person.

9. The vehicle of claim 8, wherein the second sensors are to identify the person based on comparing biometric data of the person to reference biometric data, the reference biometric data previously collected by an application executing on a mobile device associated with the person.

10. A method to pre-boot subsystems of a vehicle comprising:
detecting a person within a user set in a first radius around the vehicle with first sensors;
detecting the person within a second radius around the vehicle with second sensors;
activating, with a processor, vehicle subsystems in a first mode in response to detecting the person within the first radius; and
activating the vehicle subsystems in a second mode in response to detecting the person within the second radius.

11. The method of claim 10, wherein the second radius is smaller than the first radius.

12. The method of claim 10, including identifying, with third sensors, the person in response to the detecting the person within the second radius.

13. The method of claim 12, wherein the second sensors and the third sensors are the same sensors.

14. The method of claim 10, wherein the first mode includes downloading profiles of persons associated with the vehicle from an external server.

15. The method of claim 10, including activating electronic control units of the vehicle in a prioritized order.

16. The method of claim 15, wherein the prioritized order is based on at least one of a function of the vehicle subsystems, a total time to boot, power consumption of the vehicle subsystems.

17. The method of claim 10, including identifying the person with the second sensors in response to detecting the person within the second radius, wherein the second mode includes downloading, from an external server, infotainment data associated with a profile corresponding to the person.

18. The method of claim 17, wherein identifying the person with the second sensors includes comparing biometric data of the person to reference biometric data, the reference biometric data previously collected by an application executing on a mobile device associated with the person.
